(19) United States
(12) Patent Application Publication
(10) Pub. No.: US 2019/0129074 A1
(43) Pub. Date: May 2, 2019

(54) OPTICAL LENS AND MANUFACTURING METHOD FOR OPTICAL LENS

(71) Applicant: MITSUBISHI ELECTRIC CORPORATION, Chiyoda-ku, Tokyo (JP)

(72) Inventors: Chisako Oda, Tokyo (JP); Nobutaka Kobayashi, Tokyo (JP)

(73) Assignee: MITSUBISHI ELECTRIC CORPORATION, Chiyoda-ku, Tokyo (JP)

(21) Appl. No.: 16/094,364

(22) PCT Filed: May 1, 2017
(86) PCT No.: PCT/JP2017/017153

§ 371 Date: Oct. 17, 2018

(30) Foreign Application Priority Data
May 13, 2016 (JP) 2016-096871

(51) Int. Cl. G02B 3/04; G02B 27/09

(52) U.S. Cl. CPC G02B 3/04; C03B 11/00; G02B 27/0955

(57) ABSTRACT

An optical lens, which is to be used for forming a ring-shaped laser beam, includes: an incident surface; and an exit surface configured to face the incident surface, in which: the incident surface and the exit surface include a common optical axis, and are each perpendicular to the optical axis; the incident surface has a concave conical shape; and the exit surface has a convex shape.

### TECHNICAL FIELD

The present invention relates to an optical lens, which includes a conical surface capable of forming a ring-shaped laser beam, and a method of manufacturing an optical lens.

### BACKGROUND ART

A lens one side of which is a conical surface having a convex shape or a concave shape is referred to as “axicon lens”. The axicon lens is used for collecting light emitted from a light source along an optical axis thereof, to thereby generate a ring-shaped laser beam. A ring-shaped laser beam can be formed by the axicon lens so as to have such a characteristic that its diameter becomes larger as its irradiation distance becomes longer while its ring maintains a constant width.

This characteristic is close to a feature of a Bessel beam, which does not spread by propagation, and the intensity of a laser beam forming a ring is the same irrespective of the irradiation distance. It is also possible to form a laser beam having a large depth of focus. Owing to those characteristics, Axicon lenses are used for removal of a corneal substance during surgical operations and other purposes, and are widely applied to, for example, laser microscopes and laser processing apparatus.

In the case of using a ring-shaped laser beam formed by the above-mentioned axicon lens, it is general to use the ring-shaped laser beam in combination with another lens, for example, by causing the ring-shaped laser beam to enter an axicon lens, which is paired with the above-mentioned axicon lens, to be collimated or by causing the ring-shaped laser beam to enter a spherical lens.

In order to obtain a ring-shaped laser beam, it is also required to use an optical lens holder or other such component to adjust the position of an axicon lens so that the optical axis of a laser beam passes through the vertex of a cone of the axicon lens.

However, in the above-mentioned method, a plurality of lenses are required, and a holding member is required for each of the lenses. Therefore, the above-mentioned method has the drawback of high cost.

Further, in order to form a demanded ring shape, it is required to arrange respective lenses with their optical axes in agreement with each other and to perform position adjustment for an interval therebetween, placement angles thereof, and other such specifications with precision. However, it is extremely difficult to bring the vertex of the cone into agreement with the optical axis. In addition, the placement of a plurality of lenses requires time and labor, which leads to the drawback of an increased adjustment error.

In view of this, as a related-art optical device including a conical surface without requiring a plurality of lenses, there is an optical device including a light guide plate provided with a first concave portion formed to have a conical shape on an exit surface and a second concave portion having a columnar shape on a surface opposite to the exit surface (see, for example, Patent Literature 1).

In addition, as a related-art optical device that facilitates position adjustment, there is an optical device including a lens having characteristics of a convex lens in a first direction perpendicular to an optical axis and characteristics of a concave lens in a second direction perpendicular to the optical axis and the first direction (see, for example, Patent Literature 2).

### CITATION LIST

### Patent Literature

[PTL 1] JP 5360172 B2

[PTL 2] JP 2001-282446 A

### SUMMARY OF INVENTION

### Technical Problem

However, the related arts have the following problems. That is, the invention according to Patent Literature 1 has a configuration using a light guide plate. With such a configuration, the first concave portion having a conical shape totally reflects an entering laser beam, and hence it is not possible to form a ring-shaped laser beam.

Further, in the invention according to Patent Literature 2, neither the first direction nor the second direction has a conical shape. Therefore, even according to Patent Literature 2, it is not possible to form a ring-shaped laser beam.

The present invention has been made in order to solve the above-mentioned problems, and has an object to obtain an optical lens including a conical surface, which is capable of forming a ring-shaped laser beam with a configuration that can be manufactured with low cost and facilitates position adjustment, and a method of manufacturing an optical lens.

### Solution to Problem

According to one embodiment of the present invention, there is provided an optical lens, which is to be used for forming a ring-shaped laser beam, the optical lens including: a first surface; and a second surface configured to face the first surface, wherein the first surface and the second surface include a common optical axis, and are each perpendicular to the common optical axis, wherein the first surface has a concave conical shape, and wherein the second surface has a convex shape.

Further, according to one embodiment of the present invention, there is provided a method of manufacturing an optical lens, including: arranging a first mold for forming the first surface and a second mold for forming the second surface so as to face each other with center axes thereof in agreement with each other, and manufacturing a lens by press molding or injection molding.

### Advantageous Effects of Invention

According to one embodiment of the present invention, there is provided a configuration capable of forming light emitted from a light source into a ring-shaped laser beam with one lens and its holding member and manufacturing a lens by press molding or injection molding. As a result, it is possible to obtain an optical lens including a conical surface, which is capable of forming a ring-shaped laser beam with a configuration that can be manufactured with low cost and facilitates position adjustment, and a method of manufacturing an optical lens.

### BRIEF DESCRIPTION OF DRAWINGS

FIG. 1 is a perspective view for illustrating an optical lens including a conical surface according to a first embodiment of the present invention along with three-dimensional coordinate axes.

FIG. 2 is a sectional view of the optical lens including the conical surface according to the first embodiment of the present invention, which is taken along the line x-z.

FIG. 3 is a sectional view of the optical lens including the conical surface according to the first embodiment of the present invention, which is taken along the line x-z, for illustrating refraction of a laser beam entering from a light source.

FIG. 4 is an explanatory diagram for manufacturing the optical lens including the conical surface according to the first embodiment of the present invention by press molding.

FIG. 5 is a sectional view of an optical lens including a conical surface according to a second embodiment of the present invention, which is taken along the line x-z.

FIG. 6 are sectional views of the optical lens including the conical surface according to the second embodiment of the present invention, which is taken along the line x-z, for illustrating refraction of the laser beam entering from the light source.

FIG. 7 is a sectional view of an optical lens including an incident surface having an aspherical shape including a conical component according to a third embodiment of the present invention, which is taken along the line x-z.

FIG. 8 is a sectional view of an optical lens including a conical surface according to a fourth embodiment of the present invention, which is taken along the line x-z.

FIG. 9 is a sectional view of the optical lens including the conical surface according to the fourth embodiment of the present invention, which is taken along the line x-z, for illustrating refraction of the laser beam entering from the light source.

### DESCRIPTION OF EMBODIMENTS

Now, an optical lens including a conical surface and a method of manufacturing an optical lens according to each of preferred embodiments of the present invention are described with reference to the accompanying drawings. Substantially the same components are denoted by the same reference symbols in the respective figures. In the following embodiments, the lens can also be placed on an optical axis with its incident surface and its exit surface being reversed.

### First Embodiment

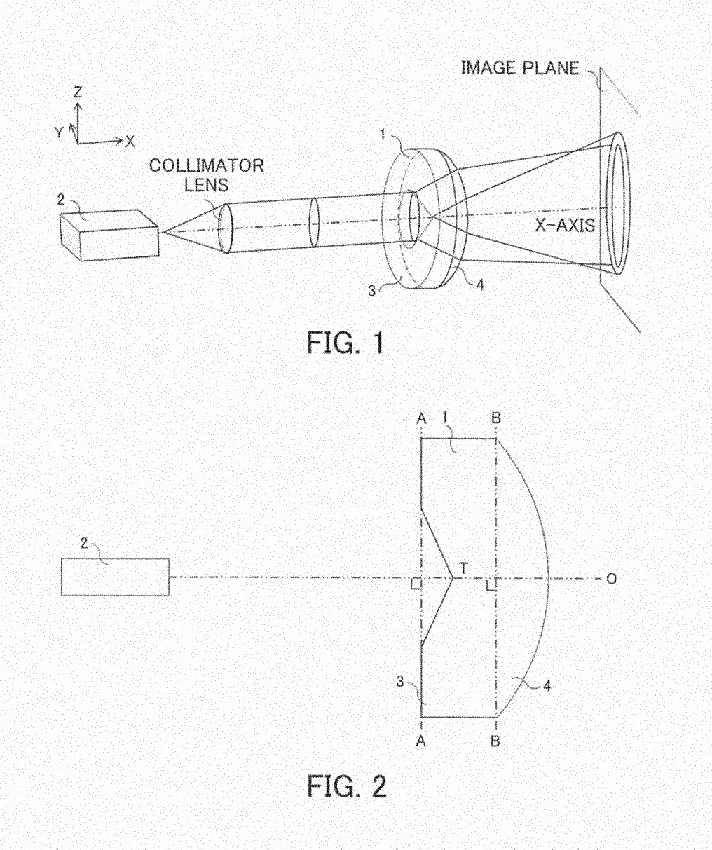

FIG. 1 is a perspective view for illustrating an optical lens 1 including a conical surface according to a first embodiment of the present invention along with three-dimensional coordinate axes. In FIG. 1, the X direction indicates an optical axis direction, in which a laser beam emitted from a light source 2 travels.

The optical lens 1 according to the first embodiment includes an incident surface 3 and an exit surface 4, which have a circular shape, and a side surface thereof. The incident surface 3 to be entered by the laser beam emitted from the light source 2 has a surface having a concave conical shape. Meanwhile, the exit surface 4 has a convex spherical shape. The incident surface 3 is placed so as to face the light source 2.

In FIG. 1, a holding member configured to hold the lens 1, an optical lens holder and a stage for position adjustment, an air-cooling or water-cooling device for cooling the lens 1, and other such components are omitted from the illustration.

FIG. 2 is a sectional view of the optical lens 1 including the conical surface according to the first embodiment of the present invention, which is taken along the line x-z. As illustrated in FIG. 2, the incident surface 3 has an optical axis O extending in the X-axis direction as its center, and includes a concave conical shape having the optical axis O as its axis. Specifically, on the surface having a conical shape being concave with respect to the X-axis direction, which is molded on the incident surface 3, a point T being the vertex of a cone overlaps with the optical axis O, and a base A-A is perpendicular to the optical axis O.

Meanwhile, the exit surface 4 has a convex spherical shape, and has the center lying on the optical axis O, and a molding surface B-B for a spherical surface is perpendicular to the optical axis. In this manner, the optical lens 1 including the conical surface according to the first embodiment has a shape and a characteristic that are obtained by integrating an axicon lens and a convex spherical lens with each other, with the incident surface 3 and the exit surface 4 being placed in parallel with each other, and the surfaces parallel with each other are perpendicular to the optical axis.

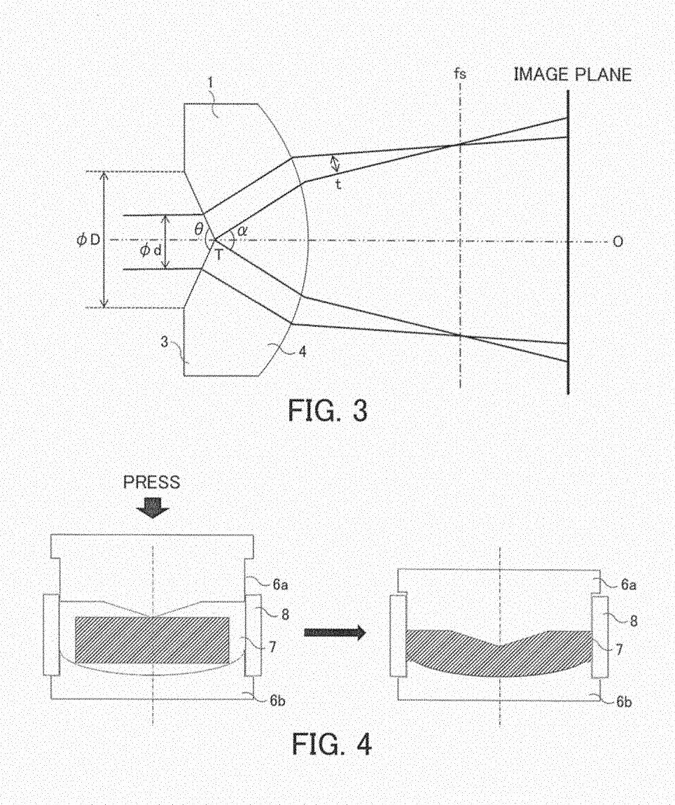

Next, with reference to FIG. 3, dimensions of a lens and a path of the light emitted from the light source 2 are described in detail. FIG. 3 is a sectional view of the optical lens 1 including the conical surface according to the first embodiment of the present invention, which is taken along the line x-z, for illustrating refraction of a laser beam entering from a light source.

The laser beam emitted from the light source 2 is formed as a laser beam parallel with the optical axis O by, for example, a collimator lens, and reaches the incident surface 3 of the optical lens 1. At this time, a diameter d of the laser beam is required to be smaller than a maximum diameter D of the conical shape on the incident surface 3.

In an isosceles triangle forming the conical surface on the section taken along the line x-z, a vertex angle for the vertex T of a cone is set as θ. The vertex angle θ can take a value within a range of:

90°≤θ<180°

based on the ring diameter of a ring-shaped laser beam to be obtained.

The laser beam that has reached the incident surface 3 enters the incident surface 3, and then has the optical path refracted as a mathematical function of the vertex angle θ and an index “n” of refraction of glass. At this time, an angle between the refracted optical path and the optical axis is set to α/2. After that, the laser beam transmitted through the lens has a ring shape having the optical axis as the center.

The laser beam transmitted through the lens then reaches the exit surface 4. In this case, the exit surface 4 in the first embodiment is molded into a convex spherical shape as described above. Therefore, due to its characteristics, the laser beam has the optical path refracted based on the index “n” of refraction and the curvature of the surface.

After that, the laser beam is emitted to an air space, and the ring-shaped laser beam travels toward a focal point fs of the convex spherical shape while reducing a width “t” thereof, and after the width “t” is set to 0 at the focal point, diffuses while increasing the width “t”.

The diameter of the ring-shaped laser beam differs depending on a distance from the lens. Therefore, by designing the vertex angle θ of the cone of the lens and the curvature of the spherical shape to have appropriate values, it is possible to obtain a ring-shaped laser beam having a required diameter.

The lens in the first embodiment is made of glass and manufactured by, for example, press molding. In another case, it is possible to manufacture the conical surface by grinding and polishing, and to manufacture a circular arc of the spherical surface by polishing. It is also possible to select a resin lens made of a polycarbonate resin or other such resin by injection molding depending on the type, output, and wavelength of the light source.

FIG. 4 is an explanatory diagram for manufacturing the optical lens 1 including the conical surface according to the first embodiment of the present invention by press molding. More specifically, FIG. 4 is a schematic diagram for illustrating the mold 6 and glass 7 to be used in the press molding.

In the case of the press molding, in order to transfer the shape of the mold 6 to the glass 7, mold surfaces of the mold 6 include a conical surface having a convex shape in an upper mold 6a for forming the incident surface 3, and have a concave shape obtained by reversing a lens shape in a lower mold 6b for forming the exit surface 4.

Those molds 6a and 6b are arranged so that one thereof slides vertically while the center axes maintain agreement with each other through use of a barrel 8 having a cylindrical shape as illustrated in, for example, FIG. 4. In addition, glass 7 is inserted between the molds 6a and 6b, and pressure is applied thereto under high temperature, to thereby manufacture the lens 1.

In this case, the molds 6a and 6b and the barrel 8 can be manufactured with precision on the order of, for example, several μm. Therefore, by manufacturing the molds 6a and 6b and the barrel 8 with high precision in terms of fitting therebetween, it is possible to bring the center axis of the conical shape and the center axis of the convex spherical shape, positioning of which has been difficult hitherto, into agreement with each other with high precision.

The volume of the glass 7 or the shapes of the mold 6 and the barrel 8 are designed so that the molded glass 7 fills the barrel 8 in contact with an inner wall surface thereof, to thereby bring the center of a lens outer diameter and the center axis of the lens into agreement with each other, and hence centering and edging processing is no longer required.

As described above, according to the first embodiment, a demanded ring-shaped laser beam can be achieved by one lens. Therefore, a plurality of lenses and their holding members are no longer required, which can reduce the number of components and can reduce cost. In addition, it is no longer required to adjust the positions of a plurality of lenses.

Further, when a lens is manufactured by press molding or injection molding, the center axis of the conical shape and the center axis of the convex spherical shape are brought into agreement with each other with high precision, and hence it is also possible to reduce an error due to adjustment. In addition, by designing the volume of glass and the shapes of a mold and a barrel so that the center of the lens outer diameter and the center axis of the lens are brought into agreement with each other, it is also possible to eliminate the need for centering and edging processing.

### Second Embodiment

In the first embodiment, the optical lens 1 including the conical surface and having the exit surface 4 formed to have a convex spherical shape is described on the assumption that the optical lens 1 is manufactured by press molding. Meanwhile, in a second embodiment of the present invention, a description is given of a case in which the exit surface 4 is a convex aspherical shape. It is possible to form an optical path having less aberrations by setting the exit surface 4 aspherical.

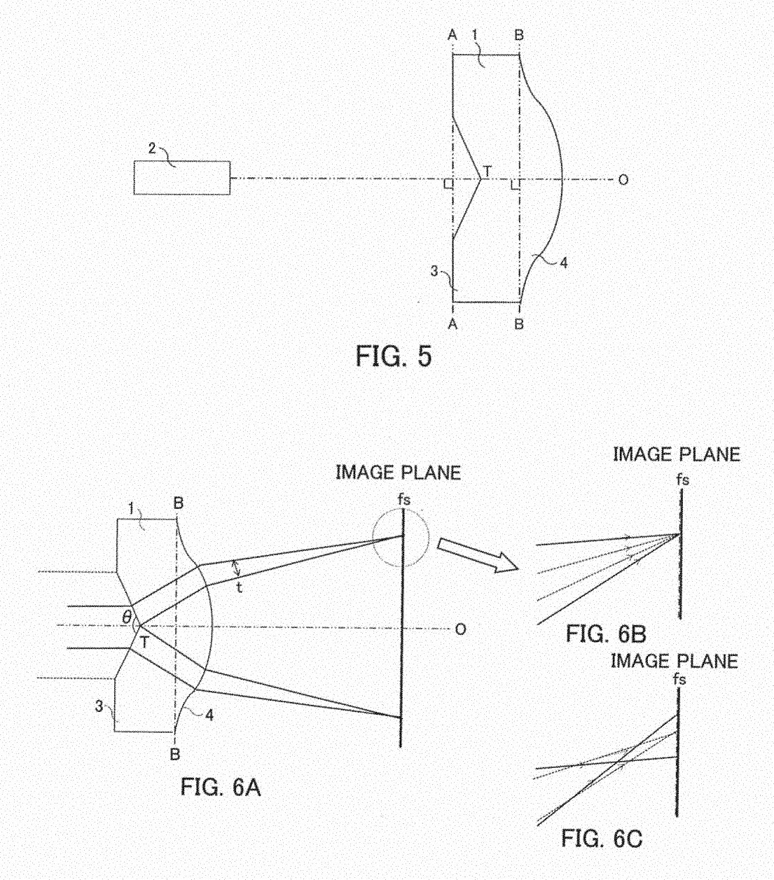

FIG. 5 is a sectional view of the optical lens 1 including a conical surface according to the second embodiment of the present invention, which is taken along the line x-z. The following description is given mainly of points different from those of the first embodiment.

In the first embodiment, a convex spherical shape is used for the exit surface 4. However, in a lens constructed of only a spherical surface, when, for example, a large-diameter lens is required, a spherical aberration becomes larger as the diameter becomes larger, which causes an adverse effect of a blurred focal point. In view of this, according to the second embodiment, it is possible to eliminate an aberration by setting the exit surface 4 aspherical.

Next, with reference to FIG. 6, dimensions of a lens and a path of the light emitted from the light source 2 are described. FIG. 6 are sectional views of the optical lens 1 including the conical surface according to the second embodiment of the present invention, which is taken along the line x-z, for illustrating refraction of a laser beam entering from a light source.

In FIG. 6, a sectional view is illustrated as FIG. 6A, while an enlarged view of a part near the focal point fs with an aspherical shape is illustrated as FIG. 6B. In addition, in order to perform comparison with FIG. 6B, an enlarged view of a part near the focal point fs with a spherical shape described in the first embodiment is illustrated as FIG. 6C.

An optical path followed by the laser beam emitted from the light source 2 to reach the exit surface 4 is the same as the path in the first embodiment illustrated in FIG. 3. In this case, the exit surface 4 in the second embodiment is formed of an aspherical shape. Therefore, due to characteristics of the aspherical shape, the laser beam has the optical path refracted based on the index “n” of refraction and the surface shape. After that, the laser beam is emitted to an air space, the ring-shaped laser beam travels toward one certain point fs in accordance with the aspherical shape while reducing the width “t” thereof to converge thereto.

In this case, for example, when a large-diameter lens is used, such a convex spherical lens as in the first embodiment causes an aberration at a focus position as illustrated in FIG. 6C. Meanwhile, with such an aspherical lens as in the second embodiment, it is possible to cause light fluxes to converge to the focal point fs as illustrated in FIG. 6B, which can eliminate a spherical aberration. After the width “t” is set to 0 at the convergence point fs, the ring-shaped laser beam in the second embodiment diffuses while increasing the width “t” again.

As described above, according to the second embodiment, the exit surface 4 is set to have an aspherical shape, to thereby be able to obtain a ring shape having a small width with no aberration even when, for example, a large-diameter lens is used. The position of the convergence point fs and the diameter of the ring-shaped laser beam differ depending on the aspherical shape. Therefore, by appropriately designing the vertex angle θ of the cone of the lens and the curvature of the aspherical shape, it is possible to obtain a ring-shaped laser beam having a required diameter.

The lens in the second embodiment is made of glass and premised on the press molding described above with reference to FIG. 4. It is also possible to select a resin lens made of a polycarbonate resin or other such resin by injection molding depending on the type, output, and wavelength of the light source.

In the case of the press molding, in order to transfer the shape of the mold 6 to the glass 7, the mold surfaces include a conical surface having a convex shape in the mold for the incident surface 3, and have a concave shape obtained by reversing the shape of the aspherical lens in the mold for the exit surface 4.

### Third Embodiment

In a third embodiment of the present invention, a description is given of a case in which the exit surface 4, which has a convex spherical shape in the first embodiment, is set to be a flat surface, and an aspherical shape including a conical component is formed for the incident surface 3. With the exit surface 4 being set to be a flat surface, the mold 6 to be used in press molding can be caused to have a simple structure, and it is also possible to reduce an error due to the fitting of the mold 6. As described in the top part of the “Description of Embodiments” section, the lens can also be placed in the optical axis with the incident surface and the exit surface being reversed.

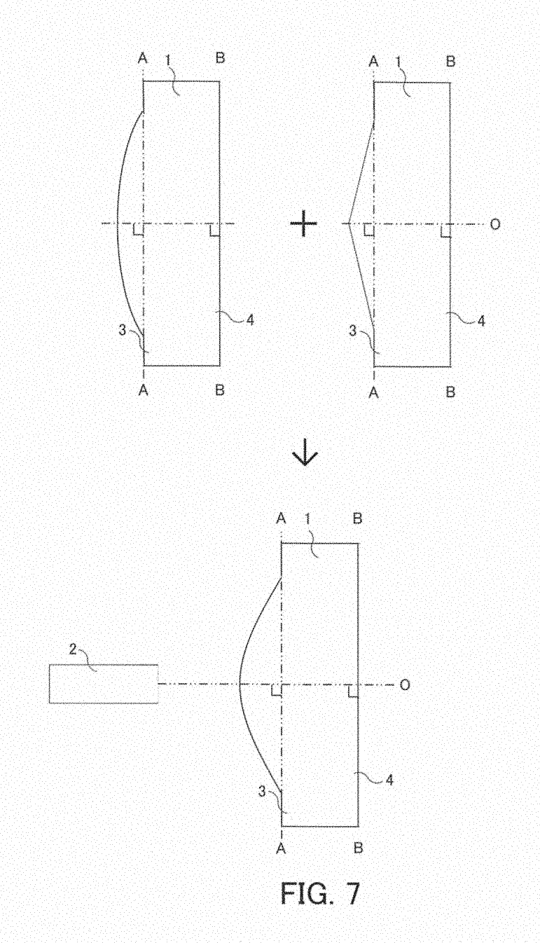

FIG. 7 is a sectional view of the optical lens 1 including an incident surface having an aspherical shape including a conical component according to a third embodiment of the present invention, which is taken along the line x-z. The following description is given mainly of points different from those of the first embodiment.

As illustrated in the sectional view of FIG. 7, the incident surface 3 has the optical axis O extending in the X-axis direction as its center, and has a convex aspherical shape having the optical axis O as its axis. In this case, the aspherical shape is a shape obtained by overlapping a conical component of an axicon lens on a convex spherical or aspherical shape. The exit surface 4 is a flat surface. At this time, the incident surface 3 and the exit surface 4 are parallel with each other.

The above-mentioned shape can be expressed by the following odd-order aspherical formula, and α₁ in the α₁r¹ term has a value other than zero.

$$z = \frac{{cr}^{2}}{1 + \sqrt{1 - ( 1 + k ) {C}^{2} {r}^{2}}} + {α}_{1} {r}^{1} + {α}_{2} {r}^{2} + {α}_{3} {r}^{3} + {α}_{4} {r}^{4} + {α}_{5} {r}^{5} + {α}_{6} {r}^{6} + {α}_{7} {r}^{7} + {α}_{8} {r}^{8}$$

In the above-mentioned formula, the meanings of the respective coefficients are as follows.

z: coordinate in the optical axis direction

r: distance from the optical axis

c: reciprocal of radius of curvature

k: conic coefficient

α₁ to α₈: aspherical coefficient

In the first embodiment, a conical surface is used as the incident surface 3, and a convex spherical shape is used as the exit surface 4. Therefore, the mold to be used in press molding is expensive, and the price becomes higher as the shape becomes more complicated. In addition, in the press molding, a high-precision lens can be molded through use of a mold, while a slight error occurs between the incident surface and the exit surface of the lens due to the fitting of the mold.

In view of this, the exit surface 4 is set to be a flat surface, and an aspherical shape including a conical component is molded on the incident surface 3, to thereby be able to simplify a mold shape. As a result, it is possible to reduce cost required for the mold, and to further reduce an error due to the fitting of the mold.

As described above, according to the third embodiment, there is provided a lens having such a structure that the exit surface is set to have a flat shape and the incident surface is formed to have an aspherical shape including a conical component. As a result, it is possible to reduce cost for a mold, and to reduce an error due to the fitting of the mold.

The lens in the third embodiment is made of glass and manufactured by the press molding described above with reference to FIG. 4. It is also possible to select a resin lens made of a polycarbonate resin or other such resin by injection molding depending on the type, output, and wavelength of the light source.

In the case of the press molding, in order to transfer the shape of the mold 6 to the glass 7, the mold surfaces have a concave shape obtained by reversing the shape of the lens having an odd-order aspherical surface in the mold for the incident surface 3, and have a flat shape in the mold for the exit surface 4.

### Fourth Embodiment

In the first embodiment, the optical lens 1 including the conical surface and having the exit surface 4 formed to have a convex spherical shape is described on the assumption that the optical lens 1 is manufactured by press molding. Meanwhile, in a fourth embodiment of the present invention, a description is given of a case in which the exit surface 4 is a convex conical shape. It is possible to more easily form a collimated ring-shaped laser beam by setting the exit surface 4 to have the conical shape.

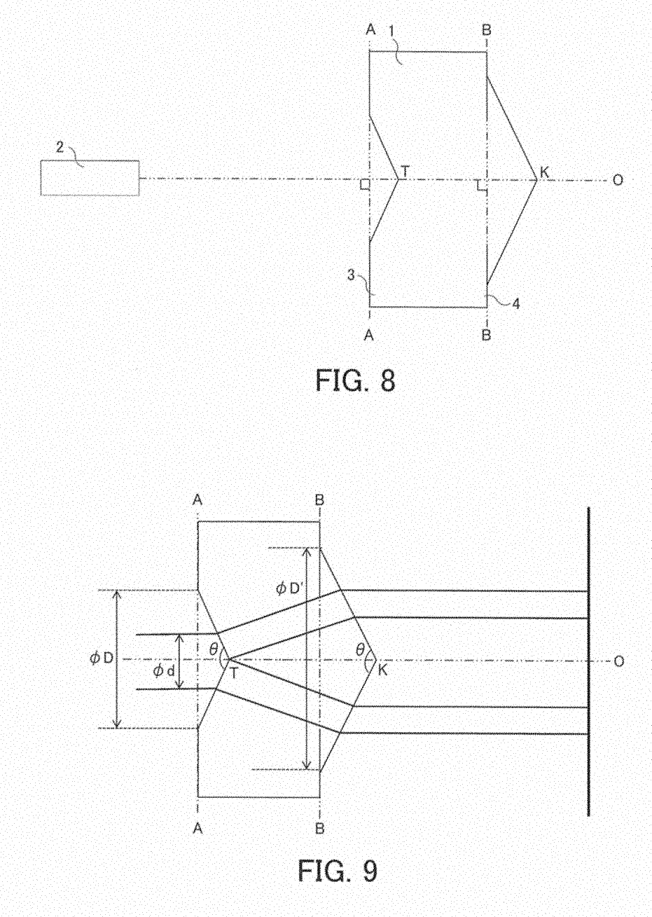

FIG. 8 is a sectional view of the optical lens 1 including a conical surface according to the fourth embodiment of the present invention, which is taken along the line x-z. The following description is given mainly of points different from those of the first embodiment.

In the first embodiment, a convex spherical shape is used for the exit surface 4. However, with a lens constructed of a spherical surface, it is not possible to obtain a collimated ring-shaped laser beam. When one more axicon lens is used, it is possible to obtain a collimated ring-shaped laser beam. However, it is difficult to place the cone vertex T of the incident surface 3 and the vertex of another axicon lens in the same optical axis.

In view of this, the fourth embodiment employs a configuration in which the exit surface 4 is set to be a convex conical surface. With such a configuration, the lens can be molded with the cone vertex T of the incident surface 3 and the vertex of the cone of the exit surface 4 being aligned with the same optical axis in a pressing stage. As a result, it is possible to obtain a collimated ring-shaped laser beam without requiring high-degree position adjustment.

As illustrated in the sectional view of FIG. 8, the exit surface 4 has the optical axis O extending in the X-axis direction as its center, and includes a convex conical shape having the optical axis O as its axis. Specifically, on the surface having a conical shape being convex with respect to the X-axis direction, which is molded on the exit surface 4, a point K being the vertex of the cone overlaps with the optical axis O, and the molding surface B-B is perpendicular to the optical axis.

At this time, there is a feature that the base A-A of the cone molded on the incident surface 3 and the molding surface B-B of the cone molded on the exit surface 4 are parallel with each other. In this manner, the incident surface 3 and the exit surface 4 of the lens in the fourth embodiment has a feature that axicon lenses each having a conical shape are arranged in alignment with each other with the optical axes being set as their rotation center.

Next, with reference to FIG. 9, dimensions of a lens and a path of the light emitted from the light source 2 are described in detail. FIG. 9 is a sectional view of the optical lens 1 including the conical surface according to the fourth embodiment of the present invention, which is taken along the line x-z, for illustrating refraction of a laser beam entering from a light source.

An optical path followed by the laser beam emitted from the light source 2 to reach the exit surface 4 is the same as the path in the first embodiment illustrated in FIG. 3. In this case, the exit surface 4 in the fourth embodiment is formed of a convex conical shape facing the incident surface 3.

The vertex angle θ at the vertex T molded on the incident surface 3 and the vertex angle θ at the vertex K molded on the exit surface 4 are the same angle, and are designed so that a laser beam emitted from the exit surface 4 is parallel with the optical axis. In addition, a maximum diameter D′ of the conical shape formed on the exit surface 4 is designed so as to become larger than the diameter of the ring obtained when the laser beam reaches the exit surface 4.

With this configuration, the optical path becomes a collimated ring-shaped laser beam when being emitted to an air space. The diameter of the ring-shaped laser beam differs depending on the vertex angle θ and a distance between the vertices T and K of the cones. Therefore, by appropriately designing the vertex angle θ of the cones of the lens and the distance therebetween, it is possible to obtain a ring-shaped laser beam having a required diameter.

With the convex spherical lens, the diameter of a ring-shaped laser beam to be obtained differs depending on the distance from the exit surface 4. Meanwhile, with the axicon lens, it is possible to obtain a ring-shaped laser beam having the same width at any position from the exit surface 4.

As described above, according to the fourth embodiment, there is provided a lens having such a structure that axicon lenses having the same vertex angle on the incident surface and the exit surface and arranged on the same optical axis are used. As a result, it is possible to easily form a collimated ring-shaped laser beam.

The lens in the fourth embodiment is made of glass and manufactured by, for example, the press molding described above with reference to FIG. 4. It is also possible to select a resin lens made of a polycarbonate resin or other such resin by injection molding depending on the type, output, and wavelength of the light source.

In the case of the press molding, in order to transfer the shape of the mold 6 to the glass 7, the mold surfaces include a conical surface having a convex shape for the incident surface 3, and include a conical surface having a concave shape for the exit surface 4. It is possible to eliminate a deviation in the optical axis by manufacturing the mold 6 with high precision.

### REFERENCE SIGNS LIST

1 optical lens, 2 light source, 3 incident surface (first surface or second surface), 4 exit surface (second surface or first surface), 5 holder, 6 mold, 7 glass, 8 barrel

1. An optical lens, which is to be used for forming a ring-shaped laser beam, the optical lens comprising:
a first surface; and
a second surface configured to face the first surface,
wherein the first surface and the second surface include a common optical axis, and are each perpendicular to the common optical axis,
wherein the first surface has a concave conical shape, and
wherein the second surface has a convex aspherical shape.

2-4. (canceled)

5. An optical lens according to claim 1, wherein a vertex angle of the conical shape on the first surface is equal to or larger than 90° and smaller than 180°.

6. An optical lens, which is to be used for forming a ring-shaped laser beam, the optical lens comprising:
a first surface; and
a second surface configured to face the first surface,
wherein the first surface and the second surface include a common optical axis, and are each perpendicular to the common optical axis,
wherein the first surface has a flat shape, and
wherein the second surface is set to be a convex odd-order aspherical surface including an odd-order term, and has a shape including a conical component and a spherical component in which a coefficient of at least a linear term is set to have a value other than zero.

7. A method of manufacturing the optical lens of claim 1, comprising:
arranging a first mold for forming the first surface and a second mold for forming the second surface so as to face each other with center axes thereof in agreement with each other, and manufacturing a lens by press molding or injection molding.

8. A method of manufacturing the optical lens of claim 6, comprising:
arranging a first mold for forming the first surface and a second mold for forming the second surface so as to face each other with center axes thereof in agreement with each other, and manufacturing a lens by press molding or injection molding.
